(19) United States
(12) Patent Application Publication
(10) Pub. No.: US 2007/0235427 A1
(43) Pub. Date: Oct. 11, 2007

(54) Apparatus and method for treating a workpiece with ionizing gas plasma

(76) Inventors: Vinay G. Sakhrani, Raleigh, NC (US); Charles Tomasino, Raleigh, NC (US)

Correspondence Address: COATS & BENNETT, PLLC, 1400 Crescent Green, Suite 300, Cary, NC, 27518, US

(21) Appl. No.: 11/732,359

(22) Filed: Apr. 3, 2007

Related U.S. Application Data
(60) Provisional application No. 60/788,933, filed on Apr. 4, 2006.

(51) Int. Cl. B23K 9/00

(52) U.S. Cl. 219/121.47

(57) ABSTRACT

An apparatus to treat a workpiece with an ionizing gas plasma at about atmospheric pressure. The apparatus may include an outer electrode with at least one opening that also serves to hold the workpiece. An inner electrode may fit at least partially within the workpiece so as to create a plasma discharge zone between the inner electrode and an inner surface of the workpiece. A gas supply manifold may be included that directs a gas into the plasma discharge zone. A power supply may be used to generate an ionizing gas plasma in the plasma discharge zone. In one embodiment, there is a coating on an inner surface of the workpiece.

### CROSS-REFERENCE TO RELATED APPLICATIONS

The present application claims the benefit of Provisional Application No. 60/788,933 filed Apr. 4, 2006, entitled “Apparatus for Plasma Treating a Workpiece and Method Therefor.”

### BACKGROUND

It is well known in the art that friction is the resistant force that prevents two objects from sliding freely when in contact with one another. There are a number of different types of frictional forces depending upon the particular motion being observed. Static friction is the force that holds back a stationary object up to the point where the object begins to move. Kinetic friction is the resistive force between two objects in motion that are in contact with one another. For any two objects in contact with one another, a value known as the coefficient of friction can be determined which is a relative measure of these frictional forces. Thus, there is a static coefficient of friction and a kinetic coefficient of friction. Stated another way, the coefficient of friction relates to the amount of force necessary to initiate movement between two surfaces in contact with one another, or to maintain this sliding movement once initiated. Because of their chemical composition, physical properties, and surface roughness, various objects have different coefficients of friction. Softer, more compliant materials such as rubber and elastomers tend to have higher coefficient of friction values (more resistance to sliding) than less compliant materials. The lower the coefficient of friction value, the lower the resistive force or the slicker the surfaces. For example, a block of ice on a polished steel surface would have a low coefficient of friction, while a brick on a wood surface would have a much higher coefficient of friction.

The difference between the static and kinetic coefficients of friction is known as “stick-slip.” The stick-slip value is very important for systems that undergo back-and-forth, stop-and-go, or very slow movement. In such systems, a force is typically applied to one of the two objects that are in contact. This force must be gradually increased until the object begins to move. At the point of initial motion, referred to as “break-out,” the static friction has been overcome and kinetic frictional forces become dominant. If the static coefficient of friction is much larger than the kinetic coefficient of friction, then there can be a sudden and rapid movement of the object. This rapid movement may be undesirable. Additionally, for slow moving systems, the objects may stick again after the initial movement, followed by another sudden break-out. This repetitive cycle of sticking and break-out is referred to as “stiction.”

In order to minimize the friction between two surfaces, a lubricant can be applied which reduces the force required to initiate and maintain sliding movement. However, when two lubricated surfaces remain in contact for prolonged periods of time, the lubricant has a tendency to migrate out from the area of contact due to the squeezing force between the two surfaces. This effect tends to increase as the force between the surfaces increases. As more of the lubricant migrates from between the two surfaces, the force required to initiate movement between the surfaces can revert to that of the non-lubricated surfaces, and stiction can occur. This phenomenon can also occur in slow moving systems. Because of the slow speed, the time interval is sufficient to cause the lubricant to migrate away from the area of contact. Once the object moves past the lubricant-depleted area, the object comes into contact with a lubricant-rich area. The frictional force is less in the lubricant-rich area and sudden, rapid movement of the object can occur.

Attempts have been made to reduce the migration of lubricant from between surfaces in contact with one another. In particular, methods exist using an energy source to treat a lubricant applied to one or more of the surfaces such that the migration is reduced. Such methods and apparatuses used in such methods have not been practical for large-scale production operations.

### SUMMARY

One embodiment comprises an apparatus for treating a surface of a workpiece with an ionizing gas plasma at about atmospheric pressure. The apparatus may include an outer electrode with at least one annular space that also serves to hold the workpiece. An inner electrode may fit at least partially within the workpiece so as to create a plasma discharge zone between the inner electrode and an inner surface of the workpiece. A gas supply manifold may be included that directs a gas into the plasma discharge zone. A power supply may be used to generate an ionizing gas plasma in the plasma discharge zone. In another embodiment, there is a coating on an inner surface of the workpiece. Still other embodiments of the invention include an apparatus to treat a coating on the inner surface of a medical device, syringe barrel, or vial.

One embodiment comprises a method of treating a surface of a workpiece using an ionizing gas plasma at about atmospheric pressure. Another embodiment comprises a method of treating a surface of a syringe barrel having a coating on the surface.

### BRIEF DESCRIPTION OF THE DRAWINGS

FIG. 1 is a perspective view of one embodiment showing the workpiece inserted into the annular space of the outer electrode and the inner electrode inserted into the hollow space of the workpiece.

FIG. 2 is an exploded view of one embodiment.

FIG. 3 is a sectional schematic view of one of the annular spaces of the outer electrode with a syringe barrel as the workpiece and having the inner electrode in place according to one embodiment.

FIG. 4 is a sectional schematic view showing the gas distribution manifold at the top of the apparatus to accommodate a workpiece that is open at only one end according to one embodiment.

### DETAILED DESCRIPTION

### Definitions

Certain terminology is used in this specification and appended claims. In order to provide a clear and consistent understanding of the specification and appended claims, including the scope to be given such terms, the following definitions are provided:

About Atmospheric Pressure. An embodiment of the invention involves the generation of an ionizing gas plasma. While gas plasmas can be produced under various levels of vacuum, the invention uses a plasma generated at essentially atmospheric pressure. While no conditions of vacuum or above-atmospheric pressure are deliberately produced by carrying out the method of the invention, the characteristics of the gas flow may create a deviation from atmospheric pressure. For example, when using a method of the invention to treat the inside of a cylindrical object, the gas flowing into the cylinder may result in a higher pressure within the cylinder than outside the cylinder. The term also means that atmospheric gases (i.e., air) are present when generating the ionizing gas plasma. Vacuum plasma systems, on the other hand, use vacuum pumps and vacuum chambers to remove nearly all atmospheric gases prior to generating an ionizing gas plasma.

Break-Out. An embodiment of the invention involves surfaces in sliding contact with one another. When the surfaces are in contact but at rest, a force must be applied to one of the surfaces to initiate movement. This applied force must be increased until the frictional forces opposing movement are overcome. The point at which the applied force just surpasses the frictional force and movement is initiated is known as break-out.

Chatter. Repetitive stick-slip movement associated with the movement of surfaces in contact with one another is known as chatter. When a lubricant is present between the surfaces, chatter can occur when the lubricant is squeezed out from between the surfaces, resulting in an increase in the coefficient of friction. A larger force must then be applied to the surfaces in order to initiate movement, which can cause a sudden, exaggerated movement. Chatter occurs when this cycle is repetitive.

Coefficient of Friction. The coefficient of friction relates to the amount of force necessary to initiate movement between two surfaces in contact with one another, or to maintain this sliding movement once initiated. Numerically, the term is defined as the ratio of the resistive force of friction divided by the normal or perpendicular force pushing the objects together.

Electron Beam Radiation. Electron beam radiation is a form of ionizing radiation produced by first generating electrons by means of an electron gun assembly, accelerating the electrons, and focusing the electrons into a beam. The beam may be either pulsed or continuous.

Friction. Friction is a resistive force that prevents two objects from sliding freely against each other.

Gamma Radiation. Gamma radiation is a type of electromagnetic waveform, often emitted at the same time the unstable nucleus of certain atoms emits either an alpha or beta particle when the nucleus decays. Gamma radiation, being an electromagnetic waveform, is similar to visible light and x-rays but of a higher energy level which allows it to penetrate deep into materials.

Gas Plasma. When sufficient energy is imparted to a gas, electrons can be stripped from the atoms of the gas, creating ions. Plasma contains free-moving electrons and ions, as well as a spectrum of electrons and photons.

Ionizing. Ionizing means that enough energy is present to break chemical bonds.

Parking. Syringes used in medical applications are often pre-filled prior to use and then stored. The amount of time between filling the syringe and discharging the syringe is known as parking time. In general, parking increases the break-out force.

Stick-Slip. The difference between static and kinetic coefficients of friction is known as stick-slip. In systems where a lubricant is present, high mating forces can squeeze the lubricant out from between the surfaces in contact with one another. An increased force is then required to initiate sliding movement of the surfaces. This movement may occur suddenly, caused by the surfaces coming into contact with a lubricant-rich area. If the lubricant is again forced out from between the surfaces, they can begin to bind. The sliding motion can stop until the force is increased enough to once again initiate movement. This alternating sticking and slipping is called stick-slip.

Stiction. The overall phenomenon of stick-slip is known as stiction.

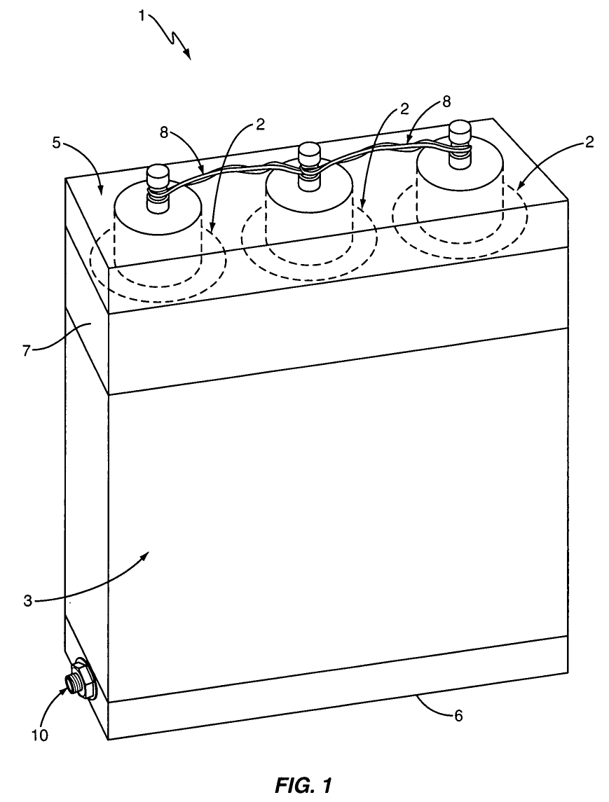

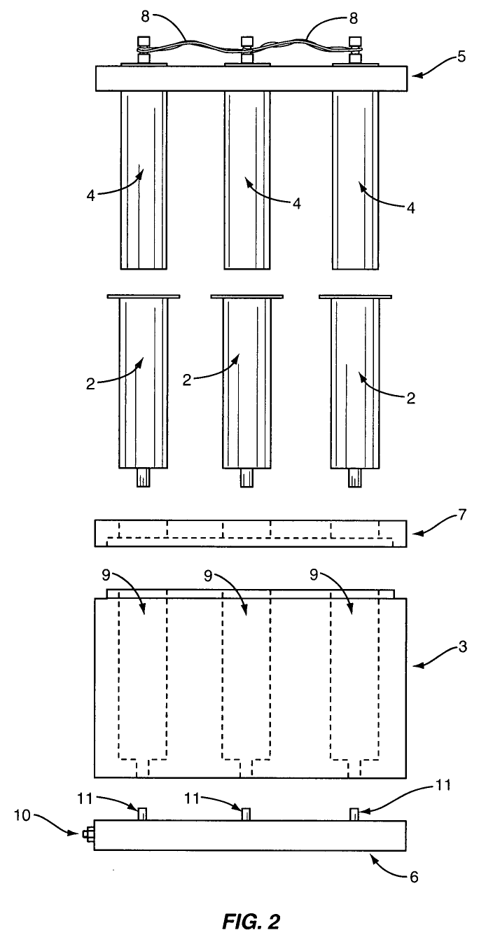

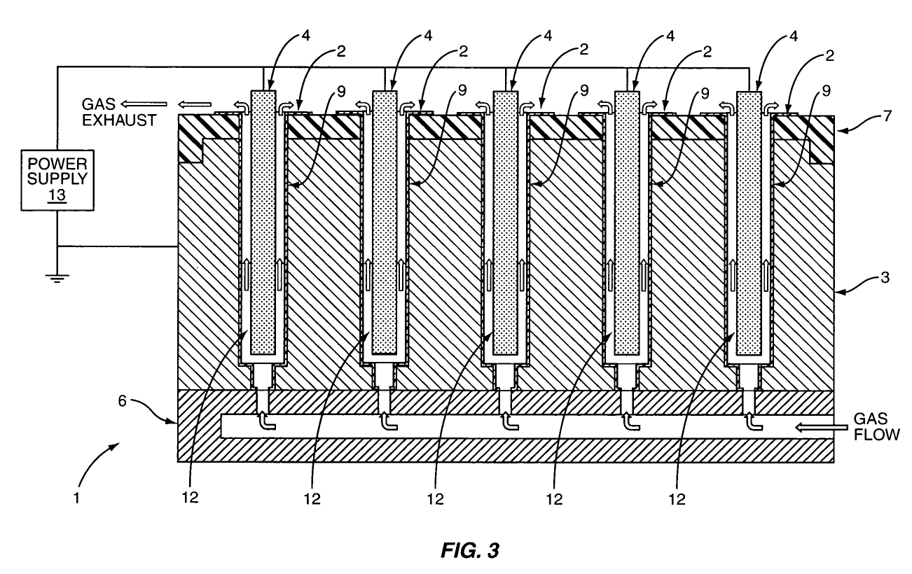

Referring in detail to the drawings, wherein like numerals represent like elements in multiple drawings, in FIG. 1 there is indicated generally an embodiment of an apparatus 1 that may be used to generate an ionizing gas plasma at about atmospheric pressure to treat a coating on at least one surface of a workpiece 2. The workpiece 2 may have a tubular shape. Alternatively, the apparatus 1 may be used to treat an uncoated surface. The workpiece 2 is shown fully inserted in an opening (FIG. 2, reference number 9) of an outer electrode 3. Thus, in FIG. 1 only an upper edge of the workpiece 2 is visible. In other embodiments the workpiece 2 may be only partially inserted into the opening 9. Refer to FIG. 2 and FIG. 3 for further detail of the relationship between the outer electrode 3, inner electrode 4, and workpiece 2. The inner electrode 4 is inserted to a predetermined depth into a hollow space of the workpiece 2. When the outer electrode 3 is adapted to contain multiple annular spaces 9, a bracket 5 to hold one or more of the inner electrodes 4 may be beneficial for maintaining proper spacing between the inner electrodes 4. The bracket 5 may also facilitate the insertion of all inner electrodes 4 simultaneously.

The opening 9 in the outer electrode 3 may generally conform to the shape of the workpiece 2. The opening 9 may be sized slightly larger than the workpiece 2 to facilitate insertion and removal of the workpiece 2. The workpiece 2 has an inner diameter, and the inner electrode 4 has an outer diameter that is smaller than the inner diameter of the workpiece 2, thereby creating an annular space between the inner electrode 4 and the inner surface of the workpiece 2. This space is known as the plasma discharge zone (FIG. 3, reference number 12). The space between the inner electrode 4 and the inner surface of the workpiece 2 may, in one embodiment, range from about 1/64 inch to about 6 inches. In another embodiment, the space is maintained within the range from about 1/64 inch to about 2 inches. This space may be measured as the difference in the inner diameter of the workpiece 2 and the outer diameter of the inner electrode 4.

Removeably attached to the bottom of the outer electrode 3 is a gas distribution manifold 6 with gas inlet fitting 10. The gas distribution manifold 6 serves to introduce a gas (or mixture of gases) in which the ionizing gas plasma will be generated into the workpiece 2 so that the gas flows in the space between the inner electrode 4 and the inner surface of the workpiece 2. In an embodiment having multiple openings 9 in the outer electrode 3, each inner electrode 4 may be electrically connected to the other inner electrodes 4, as shown by the connecting wire 8. Also shown in FIG. 1 is a dielectric layer 7 that may provide an insulating layer between the top of the outer electrode 3 and the top of the inner electrode 4 to prevent electrical arcing between the two surfaces.

FIG. 2 shows an exploded view of an embodiment of the apparatus 1. In this embodiment, three openings 9 are shown in the outer electrode 3, although any number of openings convenient to the specific embodiment may be included. The outer electrode 3 and inner electrode 4 may be constructed of a conductive material, such as aluminum. The dielectric layer 7 as shown in FIG. 2 may be constructed of a rigid plastic material so that it can be removeably attached to the top surface of the outer electrode 3. However, any type of dielectric material known in the art may be used, such as a liquid coating that is applied to the top surface of the outer electrode and subsequently allowed to dry, or a spacer that is placed between the workpiece 2 and outer electrode 3 of sufficient size to prevent electrical arcing. The gas distribution manifold 6 as shown in FIG. 2 releasably attaches to the bottom of the outer electrode 3 such that a port 11 aligns with each opening 9. The port 11 may pass through the bottom of the outer electrode 3 and may engage the bottom of the workpiece 2. The gas enters the gas distribution manifold at gas inlet fitting 10. The example workpiece 2 shown in FIG. 2 is a syringe barrel, and the port 11 engages the end of the syringe barrel and directs the gas into the hollow space of the syringe barrel. Depending on the physical shape of the workpiece 2, other embodiments of the apparatus 1 may employ different configurations of the gas distribution manifold 6. While these different configurations may differ in design from that shown in FIG. 2, the function is the same, that is, directing the gas into the workpiece 2.

FIG. 2 also depicts the opening 9, the workpiece 2, and inner electrode 4 as having a generally circular cross-section because this particular embodiment is adapted for use with syringe barrels as the workpiece 2. Other workpieces 2 may have a different cross-sectional shape, and thus the opening 9 and the inner electrode 4 may have an essentially conforming shape. The apparatus 1 is not limited to tubular workpieces with a circular cross-section.

FIG. 3 shows a cross-sectional view of an embodiment of the apparatus 1 wherein the outer electrode 3 has five openings 9 with a workpiece 2 and inner electrode 4 in place in each opening 9. The space between inner electrode 4 and the inner surface of the workpiece 2 is the plasma discharge zone 12. The gas flows from the gas distribution manifold 6 into one end of the workpiece 2. The gas flows through the plasma discharge zone 12 and is exhausted out of the opposite end of the workpiece. The energy supplied by the power supply 13 energizes the gas by means of the inner electrode 4, and may produce an ionizing gas plasma. The ionizing gas plasma may be generated at about atmospheric pressure; that is, it is not necessary to create a condition of vacuum by removing atmospheric gases from within the apparatus 1 in order to generate the ionizing gas plasma and treat the surface of the workpiece 2 or a coating on the workpiece 2. The spacing between the inner electrode 4 and inner surface of the workpiece 2 may range from about 1/64 of an inch to about 6 inches. The spacing chosen may depend on a number of factors, including the dielectric constant of the workpiece 2, the inner electrode 4 geometry, frequency of the power supply 13, and the dimensions of the surface of the workpiece 2 to be treated. In another embodiment, the spacing may range from about 1/64 inch to about 2 inches. The treatment time may range from about 0.001 second to about 5 minutes. The frequency of the power supply 13 may range from about 60 hertz to about 3 gigahertz. The power setting of the power supply 13 may be less than or equal to, for example, about 10 kilowatt. Although the exact operating parameters of the power supply 13 are not critical, the characteristics of the plasma generated by the apparatus 1 differ from a plasma generated under conditions of vacuum. Specifically, the plasma generated by the apparatus 1 may have a particle density greater than about 10²³ particles per cubic meter and an electron temperature of less than about 5 electronvolts. In comparison, vacuum plasma systems typically operate at a particle density less than about 10²¹ particles per cubic meter and an electron temperature greater than about 5 electronvolts.

To illustrate the impracticality of vacuum plasma systems (as opposed to plasma systems that operate at about atmospheric pressure) for production operations, a brief discussion of the vacuum plasma device and process is provided along with a comparison to atmospheric pressure plasma systems. The vacuum plasma process is conducted under conditions of extreme vacuum (typically less than 50 torr and in some instances less than 1 torr, compared to standard atmospheric pressure of 760 torr) in order to evacuate as much of the atmospheric gases from the vacuum chamber as possible. In the vacuum plasma process, the presence of atmospheric gases interferes with generating the ionizing gas plasma. Atmospheric pressure plasma systems are not significantly affected by the presence of atmospheric gases along with the gas in which the plasma is generated. The vacuum plasma process requires a chamber capable of withstanding the forces of extreme vacuum and having the ability to be sealed adequately to avoid leaking while under vacuum.

Atmospheric pressure plasma systems perform at atmospheric pressure, so no vacuum chamber is necessary. Sealing against leaks is no concern for atmospheric pressure plasma systems because the presence of atmospheric gases is not significant to the process, allowing the apparatus 1 to be of a relatively simple design. In order to remove the atmospheric gases from the vacuum chamber, a vacuum pump is required. The vacuum pump adds considerable cost and complexity to the apparatus. No vacuum pump is required for atmospheric pressure plasma systems. The vacuum plasma process must be a batch process because of the need to evacuate atmospheric gases from the vacuum chamber and create vacuum conditions. In contrast, atmospheric pressure plasma systems can be readily adapted to a continuous production line, resulting in a considerable improvement over a vacuum plasma system.

The gas in which the ionizing gas plasma is generated may be a noble gas including, for example, helium, neon, xenon, argon, and krypton. Alternatively, the gas may be an oxidative gas including, for example, air, oxygen, carbon dioxide, carbon monoxide, and water vapor. In yet another alternative, the gas may be a non-oxidative gas including, for example, nitrogen and hydrogen. Mixtures of any of these gases may also be used, and atmospheric gases may be also be present.

In one embodiment, the power supply 13 may be a radio frequency power supply. In another embodiment, the power supply 13 may be ionizing radiation. The ionizing radiation source can be gamma radiation or electron-beam radiation. Typically, commercial gamma irradiation processing systems use cobalt-60 as the gamma radiation source, although cesium-137 or other gamma radiation source may also be used. Commercial electron-beam radiation systems generate electrons from an electricity source using an electron gun assembly, accelerate the electrons, then focus the electrons into a beam. This beam of electrons is then directed at the material to be treated. The surface may be exposed to an ionizing radiation dosage ranging from about 0.1 megarad to about 15 megarads.

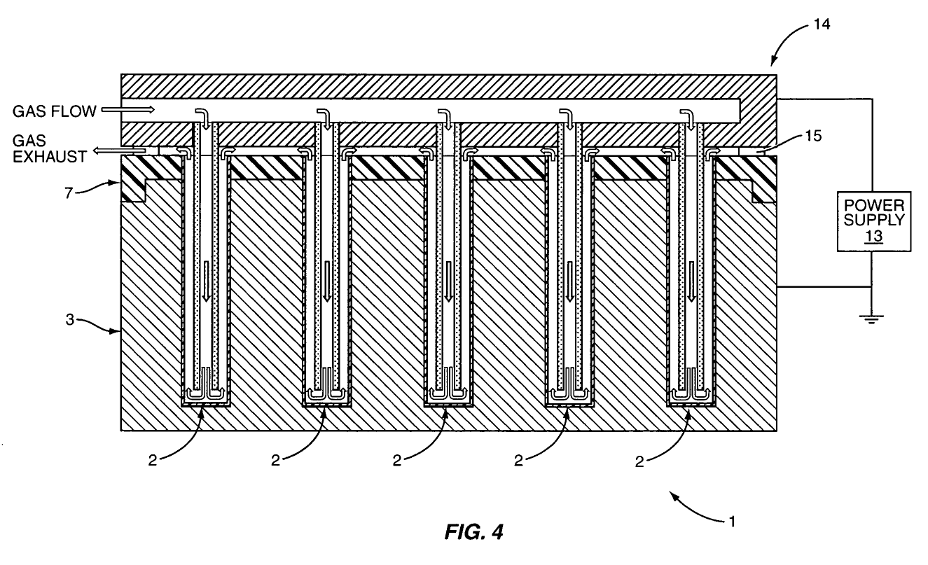

FIG. 4 shows a cross-sectional view of another embodiment where the apparatus 1 is adapted to treat a surface of a workpiece 2 that is open at only one end, such as a vial. In this embodiment, the gas cannot be supplied through the bottom of the outer electrode 3. In this case, the gas may be introduced at the top of the outer electrode 3. The gas may be supplied by, for example, a plenum 14 situated at or near the opening of the workpiece 2. One or more spacers 15 may be placed between the plenum 14 and the dielectric layer 7 to allow for the gas to exhaust from the workpiece 2.

The workpiece 2 may be made of any dielectric material. Typically, the dielectric material is a plastic, a polymer, a ceramic, or glass. The workpiece 2 may also be made of a metal with any of these dielectric materials encapsulating the electrodes.

One embodiment is a method to treat the surface of a workpiece 2, or to treat a coating on the surface of a workpiece 2. According to one embodiment, a workpiece 2 is placed in an opening 9 present in an outer electrode 3. The opening 9 may be generally the same shape as the workpiece 2 and also serves as a holder for the workpiece 2. An inner electrode 4 may then be inserted at least partially within the workpiece 2. The inner electrode 4 is smaller in diameter than the inner diameter of the workpiece 2, creating a space between the inner electrode 4 and the inner surface of the workpiece 2. This space is the plasma discharge zone. The spacing between the inner electrode 4 and the inner surface of the workpiece 2 may range from about 1/64 inch to about 6 inches. A gas is then introduced into the plasma discharge zone, and the pressure within the plasma discharge zone is maintained at about atmospheric pressure. A power supply 13 connected between the inner electrode 4 and outer electrode 3 energizes the gas, producing an ionized gas plasma. The ionizing gas plasma is produced for a predetermined period of time which may range from about 0.001 second to about 5 minutes. In another embodiment, the predetermined period of time may range from about 0.01 second to about 1 minute. When a coating is present on a surface of the workpiece 2, the method may initiate a chemical reaction between the chemical species present in the coating. The lubricity of the surface of the workpiece 2 may be greater after treatment by the method than before treatment. In another embodiment, the method may be used to treat a surface of an uncoated workpiece 2.

The embodiments described above may be useful for treating a coating applied to the surface of a workpiece. An example coating is described in U.S. patent Ser. No. 10/791,542 filed on Mar. 2, 2004, which is herein incorporated by reference in its entirety. The coating, after being treated using the apparatus 1, shows improved fixation on an inner surface of the workpiece. That is, the coating has less of a tendency to be dislodged when another surface is in sliding frictional contact with the coated surface of the workpiece. Additionally, the lubricity of the coated surface of the workpiece is improved after being treated with the present invention.

It is understood that the embodiments described herein are intended to serve as illustrative examples of certain embodiments of the apparatus and methods. Other arrangements, variations, and modifications of the described embodiments may be made by those skilled in the art. No unnecessary limitations are to be understood from this disclosure, and any such arrangements, variations, and modifications may be made without departing from the spirit of the invention and scope of the appended claims. Stated ranges include the end points of the range and all intermediate points within the end points.

We claim:

1. An apparatus to treat a workpiece, the workpiece having an inner surface and an inner dimension, comprising:
a. an outer electrode having an opening to hold the workpiece, the outer electrode configured such that the workpiece is exposed to about atmospheric pressure while treated, wherein the opening is substantially the same shape as the workpiece;
b. an inner electrode having an outer dimension less than the inner dimension of the workpiece;
c. a plasma discharge zone formed between the workpiece and the inner electrode;
d. a gas supply manifold configured to direct a gas into the plasma discharge zone; and
e. the outer electrode and the inner electrode configured to generate an ionizing gas plasma at about atmospheric pressure in the plasma discharge zone when power is supplied.

2. The apparatus of claim 1 wherein the plasma discharge zone ranges from about 1/64 inch to about 2 inches.

3. The apparatus of claim 1 wherein the outer or inner electrode further comprises a dielectric layer that electrically isolates the outer electrode from the inner electrode.

4. The apparatus of claim 1 wherein the ionizing gas plasma has a particle density greater than about 10²³ particles per cubic meter.

5. The apparatus of claim 1 wherein the ionizing gas plasma has an electron temperature of less than about 5 electronvolts.

6. The apparatus of claim 1 further comprising a plurality of openings, a plurality of inner electrodes, and a plurality of plasma discharge zones.

7. The apparatus of claim 1 wherein the opening is generally cylindrical.

8. The apparatus of claim 1 wherein the outer electrode is configured such that the workpiece is exposed to a pressure other than about atmospheric pressure while treated.

9. An apparatus to treat a workpiece, the workpiece having an inner surface and an inner diameter, the apparatus comprising an outer electrode, an inner electrode, and a gas supply manifold; wherein the outer electrode has an opening configured to hold the workpiece and the outer electrode is configured such that the workpiece is exposed to about atmospheric pressure while treated, the inner electrode has an outer diameter and is adapted to fit within the opening of the outer electrode with the workpiece therebetween and form an annular space between the inner surface of the workpiece and the inner electrode, and the gas supply manifold being configured to direct a gas into the annular space, and the outer electrode and the inner electrode configured to generate an ionizing gas plasma at about atmospheric pressure in the annular space when power is supplied.

10. The apparatus of claim 9 wherein the outer diameter of the inner electrode is adaptable to vary the annular space from about 1/64 inch to about 6 inches.

11. The apparatus of claim 9 wherein the power supply generates the ionizing gas plasma for a period of time ranging from about 0.001 second to about 5 minutes.

12. The apparatus of claim 9 wherein the ionizing gas plasma has a particle density greater than about 10²³ particles per cubic meter.

13. The apparatus of claim 9 wherein the ionizing gas plasma has an electron temperature of less than about 5 electronvolts.

14. An apparatus to treat a workpiece, the workpiece having an inner surface and an inner diameter, the apparatus comprising an outer electrode, an inner electrode, and a gas supply manifold; wherein the outer electrode has an opening configured to hold the workpiece and the outer electrode is configured such that the workpiece is exposed to about atmospheric pressure while treated, the inner electrode being adapted to fit within the outer electrode with the workpiece therebetween and form an annular space between the workpiece and the inner electrode, the gas supply manifold being configured to direct a gas into the annular space, and the outer electrode and the inner electrode configured to generate an ionizing gas plasma in the annular space wherein the ionizing gas plasma increases the lubricity of the inner surface of the workpiece as compared to the lubricity of the inner surface of the workpiece before treating.

15. The apparatus of claim 14 wherein the annular space ranges from about 1/64 inch to about 6 inches.

16. The apparatus of claim 14 wherein the power supply generates the ionizing gas plasma for a period of time ranging from about 0.001 second to about 5 minutes.

17. The apparatus of claim 14 wherein the ionizing gas plasma has a particle density greater than about 10²³ particles per cubic meter.

18. The apparatus of claim 14 wherein the ionizing gas plasma has an electron temperature of less than about 5 electronvolts.

19. A method for treating a surface of a workpiece, comprising:
a. placing the workpiece in an opening within an outer electrode, wherein the opening is substantially the same shape as the workpiece and the workpiece is exposed to about atmospheric pressure while being treated;
b. placing an inner electrode at least partially within the workpiece;
c. supplying a gas in a space between the workpiece and the inner electrode;
d. connecting a power supply between the outer electrode and the inner electrode; and
e. generating an ionizing gas plasma at about atmospheric pressure in the space between the workpiece and the inner electrode.

20. The method of claim 19 wherein the space between the workpiece and the inner electrode ranges from about 1/64 inch to about 6 inches.

21. The method of claim 19 wherein the power supply generates the ionizing gas plasma for a period of time ranging from about 0.001 second to about 5 minutes.

22. The method of claim 19 wherein the ionizing gas plasma has a particle density greater than about 10²³ particles per cubic meter.

23. The method of claim 19 wherein the ionizing gas plasma has an electron temperature of less than about 5 electronvolts.

24. The method of claim 19 wherein the outer electrode further comprises a plurality of openings each configured to be substantially the same shape as the workpiece.

25. The method of claim 24 wherein the openings are generally cylindrical.
